(19) United States
(12) Patent Application Publication
(10) Pub. No.: US 2011/0086232 A1
(43) Pub. Date: Apr. 14, 2011

(54) LAYER-BY-LAYER ASSEMBLY OF ULTRAVIOLET-BLOCKING COATINGS

(76) Inventor: Pramod K. Sharma, Ann Arbor, MI (US)

(21) Appl. No.: 12/575,552

(22) Filed: Oct. 8, 2009

(51) Int. Cl. B32B 17/06; B05D 3/14; B32B 9/00

(52) U.S. Cl. 428/432; 427/532; 428/701

(57) ABSTRACT

Methods of forming UV-blocking coatings are disclosed. Alternating layers of a negatively-charged solution and positively-charged UV-blocking materials are formed on a substrate, and optionally heated to form UV-blocking coatings. Coatings formed by the method are also disclosed.

### FIELD

The present invention relates generally to methods of making ultraviolet-blocking coatings by layer-by-layer assembly processes, and ultraviolet-blocking coatings made by such processes.

### BACKGROUND

Ultraviolet (UV) radiation, a component of sunlight, can be a damaging form of radiation in certain instances. For example, UV radiation can cause sunburns in humans. UV radiation may also damage materials exposed to sunlight. For example, UV radiation may degrade polymers and may damage textiles and paintings. Therefore, it is often desirable to block UV radiation. For example, windows that can block UV radiation may prevent at least some damage that may be caused by UV radiation.

It is known that metal oxides such as titanium dioxide, cerium oxide, zinc oxide, and other metal oxides, may be applied as thin coatings to provide some protection from UV radiation, Conventional methods of applying these thin metal oxide coatings include, for example, chemical vapor deposition (CVD), sputtering, sol-gel, etc. These conventional methods, however, may be very expensive (e.g., CVD and sputtering) and/or may require a long time to make the coatings, such as sol-gel methods, which require the formation of precursor solutions.

There is thus a long-felt need in the industry for methods of forming UV-blocking coatings that may be produced less expensively and/or at a faster rate than currently known methods. The invention described herein may, in various embodiments, solve some or all of these needs.

### SUMMARY

In accordance with various exemplary embodiments of the invention, methods of forming UV-blocking coatings, and UV-blocking coatings formed thereby are disclosed.

Various exemplary embodiments of the invention relate to methods of forming UV-blocking coatings. At least one exemplary embodiment of the invention relates to methods of forming UV-blocking coatings by a layer-by-layer assembly process. Exemplary embodiments of the invention also relate to methods of forming UV-blocking coatings by a self-assembly process.

Other exemplary embodiments of the invention relate to UV-blocking coatings. Further exemplary embodiments of the invention relate to multi-layer coatings having UV-blocking properties. In at least one embodiment of the invention, the UV-blocking coatings may be resistant to high temperatures and/or may be temperable.

As used herein, the phrase “UV-blocking coating” means a coating that blocks at least 30% of radiation having a wavelength shorter than the wavelength of visible light and longer than the wavelength of x-rays.

As used herein, the term “coating” means at least one layer. For example, a coating may comprise a single layer or may comprise more than one layer, such as two, three, or more layers. As used herein, the term “layer” means material covering a desired portion of a surface of a substrate. The layer may be continuous or discontinuous and uniform or non-uniform.

As used herein, the term “temperable” means a coating that may be heated to a temperature sufficient to temper (e.g., strengthen or toughen) a substrate on which it is formed without damaging or degrading the UV-blocking properties of the coating.

As used herein, the term “laminate” means an object having a layered structure. For example, a laminate may comprise at least one substrate, such as a glass substrate, and at least one coating, such as an UV-blocking coating formed thereon.

As used herein, the phrase “layer-by-layer” means a method of forming a plurality of layers, wherein each layer is successively formed on an underlying layer.

As used herein, the phrase “self-assembly” means a process by which layers may form on a substrate or an underlying layer due to the properties of the material comprising the new layer and the properties of the surface of the substrate or the underlying layer. For example, the surface of the substrate or underlying layer may have an electrical charge that attracts the material comprising the new layer which has the opposite charge. In a self-assembly process, the thickness of the layer may be controlled by the properties of the surface of the substrate or the underlying layer and the material of the new layer formed thereon. For example, if the surface of the substrate or underlying layer is negatively charged, the positively charged material comprising the new layer may form in a thickness such that the negative charge of the underlying surface and positive charge of the new layer are equal to one another. In various examples, once the charges are equal, the force driving the formation of the new layer (i.e., the charge differential) no longer exists and the self-assembly process terminates.

As described herein, the invention relates to methods of forming UV-blocking coatings, and UV-blocking coatings formed thereby. In the following description, certain aspects and embodiments will become evident. It should be understood that the invention, in its broadest sense, could be practiced without having one or more features of these aspects and embodiments. It should be understood that these aspects and embodiments are merely exemplary and explanatory, and are not restrictive of the invention as claimed.

### BRIEF DESCRIPTION OF THE DRAWINGS

The following figures, which are described below and which are incorporated in and constitute a part of the specification, illustrate exemplary embodiments of the invention and are not to be considered limiting of the scope of the invention, for the invention may admit to other equally effective embodiments.

FIG. 1 is a schematic representation of an exemplary UV-blocking coating formed on a substrate according to an embodiment of the invention;

FIG. 2 is a schematic representation of a substrate comprising an exemplary UV-blocking coating with an exemplary IR-blocking coating according to an embodiment of the invention; and

FIGS. 3A-3H are schematic representations of an exemplary method of forming UV-blocking coatings on a substrate according to an embodiment of the invention.

### DESCRIPTION OF EXEMPLARY EMBODIMENTS

Reference will now be made to various exemplary embodiments of the invention, examples of which are illustrated in the accompanying figures. However, these various exemplary embodiments are not intended to limit the disclosure, but rather numerous specific details are set forth in order to provide a thorough understanding of the invention. It will be apparent to one skilled in the art that the invention may be practiced without some or all of these specific details, and the disclosure is intended to cover alternatives, modifications, and equivalents. For example, well-known features and/or process steps may not have been described in detail so as not to unnecessarily obscure the invention.

The present invention contemplates various exemplary methods of forming UV-blocking coatings.

At least one exemplary embodiment of the invention contemplates methods of forming UV-blocking coatings by a layer-by-layer assembly process. In at least one exemplary embodiment, the UV-blocking coatings may be formed by a self-assembly process.

In at least one embodiment, a UV-blocking coating, which may comprise one or more layers, may comprise a metal oxide. The metal oxide may be chosen from any metal oxide capable of blocking UV radiation, such as, for example, titanium oxides, cerium oxides, zinc oxides, barium titanate, and strontium titanate. In at least one embodiment, the metal oxide is chosen from titanium oxides and cerium oxides. In at least one further embodiment, the UV-blocking coating may comprise more than one metal oxide, such as, for example, a combination of titanium oxides and cerium oxides. In at least one embodiment, the UV-blocking coating may comprise at least one additional element chosen from a filler and a colorant.

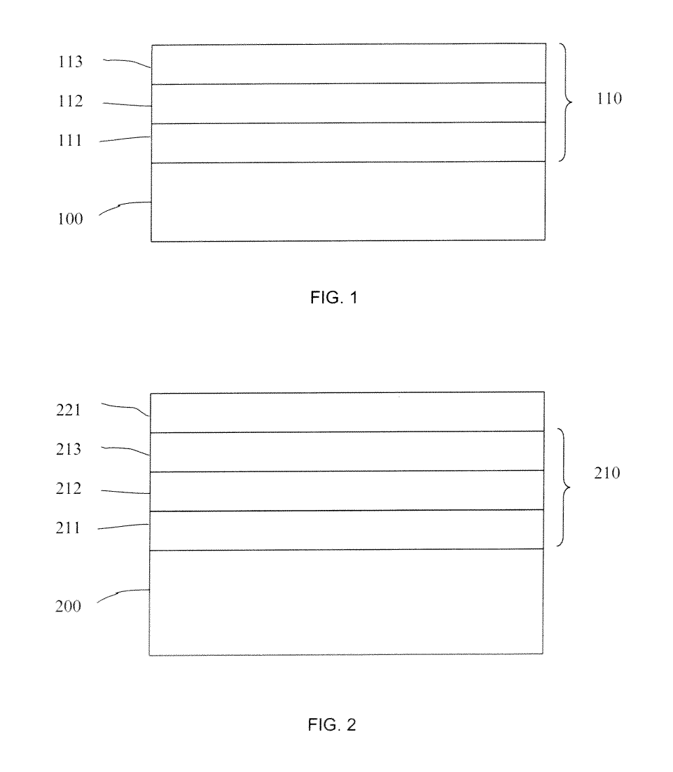

In at least one exemplary embodiment, the UV-blocking coating may comprise at least one layer of metal oxide, wherein the at least one layer may be formed on a substrate. For example, the UV-blocking coating may, in one exemplary embodiment, comprise a single layer of metal oxide, or the UV-blocking coating may comprise a plurality of metal oxide layers. In at least one embodiment, the UV-blocking coating may comprise at least one layer of at least one metal oxide. The UV-blocking coating may, for example, comprise a layer comprised of one or more metal oxides, such as a layer comprised of a combination of titanium oxides and cerium oxides. The UV-blocking coating may, in a further exemplary embodiment, comprise layers comprised of different metal oxides, such as a layer comprised of titanium oxides and a layer comprised of cerium oxides. An exemplary embodiment of a UV-blocking coating on a substrate is shown in FIG. 1. In FIG. 1, an exemplary coating 110 comprises three UV-blocking layers 111, 112, and 113, and is formed on substrate 100.

According to various embodiments, the UV-blocking coating may be formed by depositing particles of a metal oxide on a substrate. In at least one embodiment, the particles of metal oxide may be nanoparticles. In one exemplary embodiment, the particles of metal oxide may be charged particles, and the substrate may have an oppositely charged surface. For example, the particles of metal oxide may be positively charged and at least one surface of the substrate may be negatively charged. Positively-charged metal oxide particles are commercially available, such as, for example, positively-charged nanoparticles of titanium dioxide from Toto, Japan, or positively-charged nanoparticles of cerium oxide from Nyacol, U.S.A.

According to at least one embodiment of the invention, the UV-blocking coating may be formed by a self-assembly process. In at least one embodiment, the surface of the substrate may be charged by providing a positively-charged or negatively-charged polyelectrolyte on the surface of the substrate. For example, a negatively-charged polyanionic solution may be provided on the surface of the substrate. Exemplary polyanionic solutions may be include, for example, sodium poly(styrenesulfonate) (PSS), poly(3-thiophene acetic acid), poly(acrylic acid), and sulfonated polyaniline. In an exemplary embodiment, an aqueous solution of sodium poly(styrenesulfonate) may be used to provide a negatively-charged substrate surface by coating the surface of the substrate with negatively-charged poly(styrenesulfonate).

In at least one embodiment, the surface of the substrate may be made positively charged before providing a negative charge to the substrate surface. Without wishing to be limited by theory, it is believed that providing a positive charge to the substrate surface prior to applying a negatively-charged solution may provide greater surface coverage of the negatively-charged solution. For example, a positively-charged solution may evenly coat the surface of the substrate with positive charges that provide a surface that may be more uniformly covered with a negatively-charged solution. In at least one embodiment, a positively-charged polycationic solution may be applied to the surface of the substrate by any known coating method prior to applying the polyanionic solution. Exemplary positively-charged polycationic solutions may include poly(diallyldimethyl ammonium) chloride (PDDC), poly(allylamine), and poly(allylamine hydrogen) chloride. Subsequently, a negatively-charged polyelectrolyte may, in various exemplary embodiments, be applied to the positively-charged surface of the substrate as described above.

In various exemplary embodiments, after the surface of the substrate is negatively charged, with or without the preceding positive charge, the surface of the substrate may subsequently be coated with a layer comprising at least one positively-charged metal oxide. The substrate may be coated with the at least one metal oxide by any known method. For example, the coating may be formed by spin-coating, dipping, flow coating, spraying, brushing, etc.

After the coating comprising at least one metal oxide has been formed on the substrate, the coating may, in various exemplary embodiments, be heat treated. The heat treatment may be performed using any known heat-treatment method, such as, for example, a furnace, a burner, etc. Heat treating may burn off or remove any polyanion or polycation that was applied to the substrate, leaving only a layer of metal oxide.

According to various embodiments of the invention, the UV-blocking coating may comprise a plurality of layers, formed layer by layer. In at least one embodiment, the layer-by-layer formation may be a self-assembling process by repeating the steps described above. For example, a plurality of layers may be formed by (a) applying a polyanionic solution to at least one surface of a substrate, (b) coating the at least one surface of the substrate with a layer comprising at least one positively-charged metal oxide, and repeating steps (a) and (b) to form a plurality of layers. Before forming the first layer, the surface of the substrate may be rendered positively charged by coating the surface of the substrate with a polycationic solution. After the final layer has been applied, the coating may be heat treated to remove the polyanion and any polycation that may have been applied. In at least one embodiment, each layer of the coating may have a thickness ranging from 10 nm to 100 nm. For example, each layer may comprise a monolayer of particles, i.e., a layer of particles equal to the thickness of the particles. One of ordinary skill in the art will recognize that the thickness of the UV-blocking coating may be chosen based on various factors known to those of skill in the art, such as, for example, the balance between desired UV-blocking properties of the coating and the desired light transmission of the coating. A thicker coating will generally block more UV radiation, but may also allow less light to be transmitted through the coating.

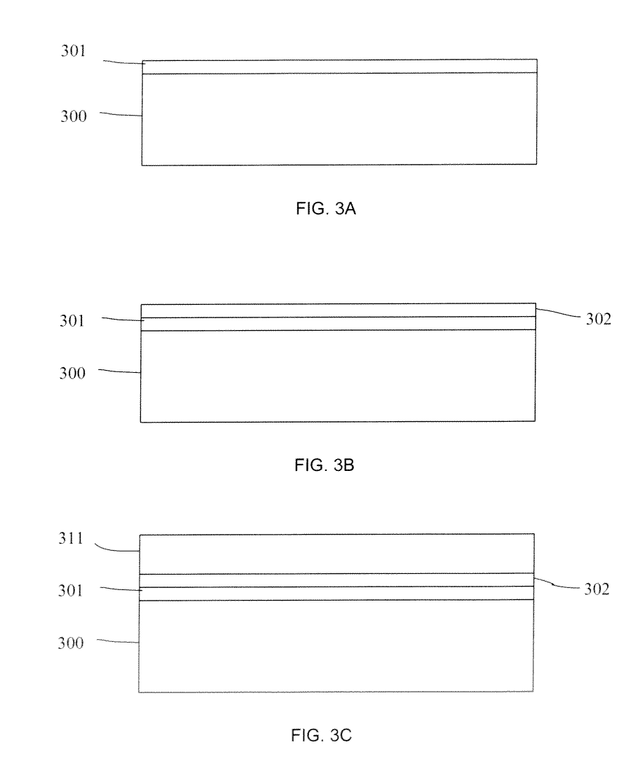

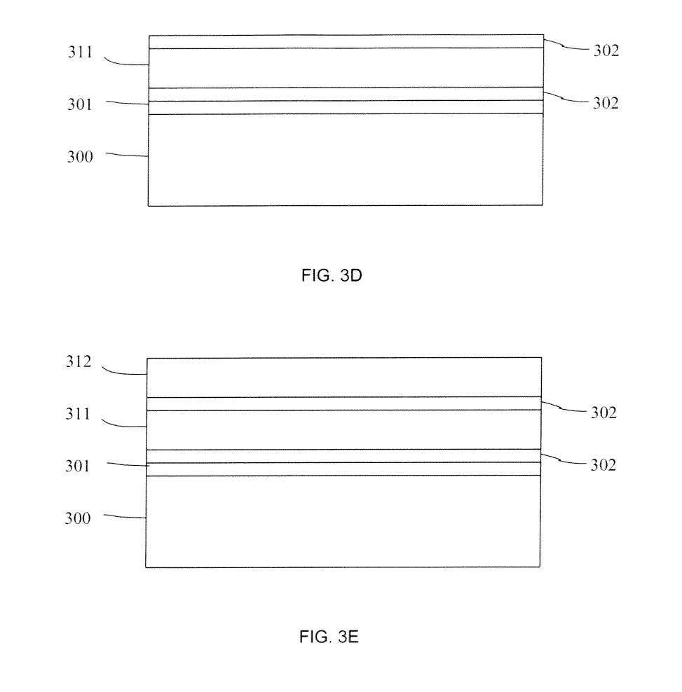

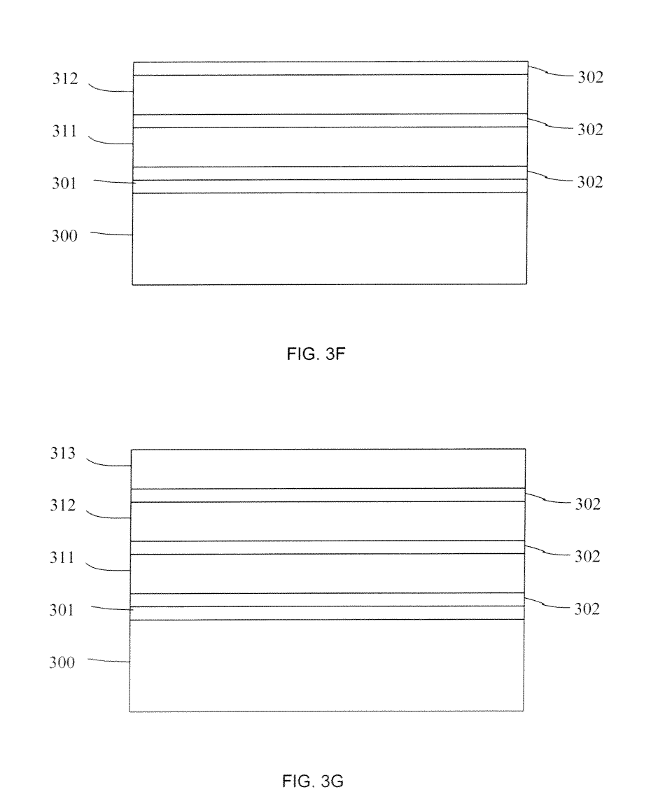

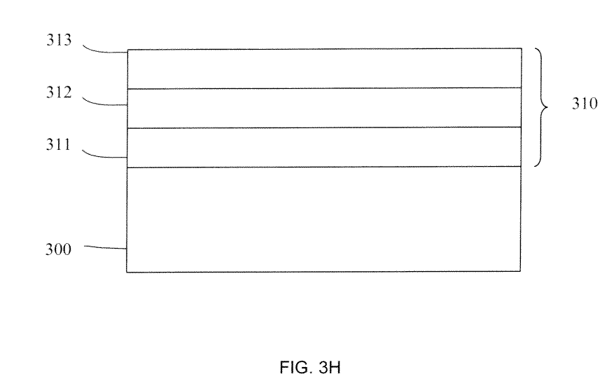

An exemplary embodiment according to a method of the invention is shown in FIGS. 3A-3H. In FIG. 3A, a substrate 300 is provided and a polycationic layer 301 is applied to a surface of substrate 300. In FIG. 3B, a polyanionic layer 302 is applied above the polycationic layer 301. In FIG. 3C, a first metal oxide layer 311 is formed on the polyanion layer 302 by applying positively-charged nanoparticles of metal oxide. In FIG. 3D, a second polyanion layer 302 is applied on the first metal oxide layer 311, followed by, in FIG. 3E, a second metal oxide layer 312. In FIG. 3F, a third polyanion layer 302 is applied on the second metal oxide layer 312, and in FIG. 3G, a third metal oxide layer 313 is formed on the third polyanion layer 302. in FIG. 3H, the substrate 100 and layers are heat treated to remove the polycations and polyanions, thus forming UV-blocking coating 310 comprised of metal oxide layers 311, 312, and 313.

In at least one embodiment, the substrate may comprise glass, such as, for example, clear float glass or low-iron glass.

In at least one exemplary embodiment, the substrate may further comprise additional coatings, such as, for example, an infrared (IR) coating. For example, in FIG. 2, an UV-blocking coating 210 comprised of metal oxide layers 211, 212, and 213 is formed over substrate 200. An IR-blocking coating 221 is formed over the UV-blocking coating 230.

The present invention is further illustrated by the following non-limiting examples, which are provided to further aid those of skill in the art in the appreciation of the invention.

Unless otherwise indicated, all numbers herein, such as those expressing weight percents of ingredients and values for certain physical properties, used in the specification and claims are to be understood as being modified in all instances by the term “about,” whether so stated or not. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, a “wt %” or “weight percent” or “percent by weight” of a component, unless specifically stated to the contrary, is based on the total weight of the composition or article in which the component is included. As used herein, all percentages are by weight unless indicated otherwise.

It is noted that, as used in this specification and the appended claims, the singular forms “a,” “an,” and “the,” include plural referents unless expressly and unequivocally limited to one referent, and vice versa. Thus, by way of example only, reference to “a substrate” can refer to one or more substrates, and reference to “a metal oxide” can refer to one or more metal oxides. As used herein, the term “include” and its grammatical variants are intended to be non-limiting, such that recitation of items in a list is not to the exclusion of other like items that can be substituted or added to the listed items.

It will be apparent to those skilled in the art that various modifications and variation can be made to the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

### EXAMPLES

### Comparative Example

A glass substrate having a UV transmittance of 72.13% and visible light transmittance of 91.32% was used as a control to compare the effect of the coatings of the Examples.

### Example 1

A glass substrate was coated with a poly(diallyldimethyl ammonium) chloride (PDDC) solution (1 wt % PDDC in water) using a flow-coating method and dried for 2 minutes. The PDDC-coated substrate was immersed in deionized water for 3 minutes and then dried with nitrogen gas. The substrate was then coated with a sodium poly(styrenesulfonate) (PSS) solution (1 wt % PSS in water) and dried for 2 minutes. The substrate was immersed in deionized water for 3 minutes and dried with nitrogen gas. A coating of titanium dioxide was formed on the PSS coating by flow-coating a positively-charged nanoparticle solution of titanium dioxide (TOTO, Japan; 1 wt % titanium dioxide particles <25 nm in water) and then dried for 3 minutes. The coating was heat treated over a heat source at 625° C. for 3.5 minutes. The UV transmittance of the titanium dioxide coated glass was 72.12% and the visible light transmittance was 91.08%.

### Example 2

The UV-blocking coating of Example 2 was made according to the same method described above for Example 1. In the coating of Example 2, a second layer of PSS was formed on the first layer of titanium dioxide and a second layer of titanium dioxide was formed on the second layer of PSS to form a layer-by-layer assembly comprising the substrate, a PDDC layer, a first PSS layer, a first titanium dioxide layer, a second PSS layer, and a second titanium dioxide layer. The coating was heat treated at 625° C. for 3.5 minutes. The titanium dioxide coated glass of Example 2 had a UV transmittance of 60.00% and a visible light transmittance of 81.59%.

### Example 3

The UV-blocking coating of Example 3 was made using the same procedure described above in Examples 1 and 2 to form substrate with three layers of PSS and three layers of titanium dioxide (e.g., a stack comprised of substrate:PDDC:PSS:titanium dioxide:PSS:titanium dioxide:PSS:titanium dioxide). The titanium dioxide coated glass of Example 3 had a UV transmittance of 54.04% and a visible light transmittance of 86.58%. It was believed that the increased visible light transmission observed in Example 3 was due to variations in the surface thickness.

### Example 4

In Example 4, a single layer UV-blocking coating was made using the same method described above for Example 1. In Example 4, however, a solution containing positively-charged cerium oxide particles (Nyacol, US; 1 wt % cerium oxide particles <25 nm in water) was spin-coated at 1000 rpm for 30 seconds in place of the titanium dioxide particles in Example 1. The stacked layers of PDDC, PSS, and cerium oxide were heat treated at 625° C. for 3.5 minutes to remove the PDDC and PSS and form the UV-blocking coating of cerium oxide. The cerium dioxide coated glass of Example 4 had a UV transmittance of 24.21% and a visible light transmittance of 76.77%.

### Example 5

In Example 5, a stack of layers comprising two layers of PSS and two layers of cerium oxide were formed on a PDDC-coated substrate using the same procedure described above in Example 4. The resulting substrate:PDDC:PSS:cerium oxide:PSS:cerium oxide laminate was heat treated at 625° C. for 3.5 minutes to remove the PDDC and PSS and form the UV-blocking coating of cerium oxide. The cerium dioxide coated glass of Example 5 had a UV transmittance of 13.61% and a visible light transmittance of 62.02%.

### Example 6

In Example 6, a substrate:PDDC:PSS:cerium oxide:PSS:cerium oxide:PSS:cerium oxide laminate was formed by the same procedure described above for Example 4 and then heat treated at 625C. for 3.5 minutes to remove the PDDC and PSS and form the UV-blocking coating of cerium oxide. The cerium dioxide coated glass of Example 6 had a UV transmittance of 12.56% and a visible light transmittance of 27.92%.

As demonstrated by Examples 1-6, as the number of metal oxide layers used to form the UV-blocking coating increased for each type of metal oxide, the amount of UV radiation that was blocked also increased. The amount of visible light transmitted by the coating also decreased with increased numbers of metal oxide layers.

What is claimed is:

1. A method of forming a UV-blocking coating comprising:
providing a substrate;
providing a negative charge to a surface of the substrate to form a negatively-charged surface;
coating the negatively-charged surface of the substrate with a layer comprising at least one positively-charged metal oxide; and
heating the coated substrate to form a coating of metal oxide.

2. The method of claim 1, wherein the at least one positively-charged metal oxide is chosen from titanium oxides, cerium oxides, zinc oxides, barium titanate, and strontium titanate.

3. The method of claim 1, wherein the at least one positively-charged metal oxide comprises more than one metal oxide.

4. The method of claim 1, wherein providing a negative charge to the surface of the substrate comprises coating the surface of the substrate with a polyanion.

5. The method of claim 4, wherein the polyanion comprises sodium poly(styrenesulfonate), poly(3-thiophene acetic acid), poly(acrylic acid), and sulfonated polyaniline.

6. The method of claim 1, further comprising providing a positive charge to the surface of the substrate to form a positively charged surface prior to providing the surface of the substrate with a negative charge.

7. The method of claim 6, wherein providing the positive charge to the surface of the substrate comprises coating the surface of the substrate with a polycation.

8. The method of claim 7, wherein the polycation is chosen from poly(diallyldimethyl ammonium) chloride, poly(allylamine), and poly(allylamine hydrogen) chloride.

9. The method of claim 1, further comprising repeating the steps of providing a negative charge on the surface of the substrate and coating the surface of the substrate with the layer of at least one positively-charged metal oxide to form a laminate of at least two metal oxide layers.

10. The method of claim 9, wherein at least two of the metal oxide layers comprise different metal oxides.

11. The method of claim 1, wherein the substrate is glass.

12. The method of claim 11, wherein the substrate is chosen from clear glass and low-iron glass.

13. The method of claim 1, wherein the coated substrate is heated at a temperature of about 600° C. or greater.

14. The method of claim 1, further comprising forming an IR-blocking coating over the substrate.

15. A laminate comprising:
a substrate;
an UV-blocking coating comprising a plurality of layers wherein each layer is independently comprised of at least one metal oxide.

16. The laminate of claim 15, wherein the UV-blocking coating comprises at least one layer comprised of at least one first metal oxide, and at least one layer comprised of at least one second metal oxide, wherein the at least one first metal oxide and the at least one second metal oxide are different.

17. The laminate of claim 15, wherein the at least one metal oxide is chosen from titanium dioxide, cerium dioxide, zinc oxide, barium titanate, and strontium titanate.

18. The laminate of claim 17, wherein the at least one metal oxide is chosen from titanium dioxide and cerium dioxide.

19. The laminate of claim 15, wherein the substrate is chosen from clear glass and low-iron glass.

20. The laminate of claim 15, further comprising an IR-blocking coating.
